(19) United States
(12) Patent Application Publication
(10) Pub. No.: US 2012/0156355 A1
(43) Pub. Date: Jun. 21, 2012

(54) VEGETABLE PROTEIN MEAT ANALOGUES AND METHODS OF MAKING THE SAME

(75) Inventors: Jeffrey J. Milne, Lenexa, KS (US); Widya R. Paramita, Roscoe, IL (US); Jack William Maegli, Beloit, WI (US)

(73) Assignee: KERRY GROUP SERVICES INTERNATIONAL, LTD., Tralee (IE)

(21) Appl. No.: 13/408,835

(22) Filed: Feb. 29, 2012

Related U.S. Application Data
(63) Continuation of application No. 12/154,329, filed on May 22, 2008.

(51) Int. Cl. A23L 1/31

(52) U.S. Cl. 426/574

(57) ABSTRACT

Meat analogue products and methods of making these products are provided. The products are made from compositions comprising a mixture of ingredients, including a vegetable protein, a dough conditioner, and less than about 25% by weight flour. These compositions can optionally further comprise: thermally-preformed, texturized, protein components; oils and/or fats; flavors; spices; seasoning; colors; acids; and preservatives. These products can be provided in a log or slab formation and cut into dices, slices, cubes or any other desired geometry, and packaged and/or further processed as necessary (e.g., added to pizza products). Novel methods for the continuous manufacture of these products using a forming heat exchanger are also provided. This continuous process provides casingless food products analogous to meat products such as pepperoni.

### RELATED APPLICATIONS

This application is a continuation of U.S. patent application Ser. No. 12/154,329, filed May 22, 2008, and entitled VEGETABLE PROTEIN MEAT ANALOGUES AND METHODS OF MAKING THE SAME, incorporated by reference herein.

### BACKGROUND OF THE INVENTION

1. Field of the Invention

The present invention is broadly concerned with novel, meat analogue food products having improved texture and flavor and novel processes for manufacturing these products using a continuous manufacturing method.

2. Description of the Prior Art

Typically, meat analogue food products are created by mixing the ingredients in a mixing bowl, extruding the homogenous mixture into a casing, cooking and smoking the product in a smokehouse to form the mixture into a desired shape, and subsequently removing the casing.

Meat analogue food products containing no meat or substantially reduced levels of meat are well known. Meat analogue products have been prepared that attempt to approximate the juiciness and tenderness properties of an all-meat product. However, the texture of these products do not adequately simulate meat. Other food compositions have been prepared that include a cereal hydrolysate and a hydrocolloid gum that mimic fat for use in low-fat, comminuted meat products. Many of these products incorporate a gum into a sausage or other food composition. Other approaches incorporate low levels of meat within vegetable-based foods, so they are not acceptable options for strict vegetarians and vegans.

There is a need for formed, meat analogues having improved texture and flavor components that more approximate the flavor and texture of real meat. There is also a need for an efficient and continuous method of forming meat analogues that avoids the shortcomings of the traditional batch casing process.

### SUMMARY OF THE INVENTION

The present invention fills this need by broadly providing meat analogue compositions, products and methods of forming such products by a forming heat exchanger.

In one embodiment, there is provided a method of forming a meat analogue product. The method comprises preparing a mixture of ingredients including at least one vegetable protein, a dough conditioner, and water; heating the mixture to a temperature not exceeding the gel point of said mixture; and subsequently passing the mixture through a heat exchanger to form the meat analogue product.

In another embodiment, a meat analogue composition is provided. The composition comprises a mixture of ingredients including a vegetable protein, a dough conditioner, and less than about 25% by weight flour, based upon the total weight of all ingredients other than water, taken as 100% by weight.

In a further embodiment, there is provided a meat analogue product. The meat analogue product comprises a self-sustaining body, which comprises a vegetable protein, a dough conditioner, and less than about 15% by weight flour, based upon the total weight of the body taken as 100% by weight. The self-sustaining body also has a hardness of at least about 2,000 g.

Advantageously, this meat analogue product can be formed using a continuous process and without the use of a casing. Other advantages of the present invention will become apparent based upon the detailed description below, which illustrates preferred embodiments of the present invention.

### DETAILED DESCRIPTION OF PREFERRED EMBODIMENTS

In more detail, the inventive meat analogue composition comprises a mixture of ingredients including a vegetable protein, a dough conditioner, and less than about 25% by weight flour, based upon the total weight of all ingredients in the composition other than water taken as 100% by weight. As used herein, the phrase “all ingredients other than water” means that the weight is calculated based upon the total weight of all ingredients included in the composition, except for the water that is added to the composition either before, during, or after the ingredients are mixed. Thus, “the total weight of all ingredients other than water” would include the weight of moisture that may be inherently present in some of the ingredients that are utilized, but it would not include the weight of water that is added as a separate ingredient, such as during extrusion.

The composition should comprise at least about 15% by weight vegetable protein, preferably from about 15% to about 90% by weight, more preferably from about 25% to about 65% by weight, and even more preferably from about 35% to about 50% by weight, based upon the total weight of all ingredients other than water taken as 100% by weight. Examples of suitable vegetable proteins include those selected from the group consisting of vital wheat gluten, soy protein isolate, soy protein concentrate, hydrolyzed wheat protein, pea protein, pea protein concentrate, and mixtures thereof. It is particularly preferred that the vegetable protein used in the meat analogue composition be a powdered vegetable protein, such as powdered vital wheat gluten, powdered soy protein isolate, powdered soy protein concentrate, etc.

The total dough conditioner should be present in the composition at a level of at least about 0.001% by weight, preferably from about 0.001% to about 0.5% by weight, more preferably from about 0.01% to about 0.3% by weight, and even more preferably from about 0.04% to about 0.2% by weight, based upon the total weight of all ingredients other than water taken as 100% by weight. The term “dough conditioner,” as used herein, refers to conditioners, reducing agents, and protein solubilizers capable of softening the protein molecules and reducing mixing time. In particular, preferred dough conditioners disrupt the disulfide bonds between and within the protein molecules, weakening the protein structure. Since the intramolecular disulfide bonds rapidly disconnect, the proteins unfold quickly with less mixing. Suitable dough conditioners include L-cysteine, sulfites, dextrin, reduced glutathione, transglutamase, derivatives or sources of the foregoing, and combinations of the foregoing. In a particularly preferred embodiment, the dough conditioner is L-cysteine hydrochloride, a derivative of L-cysteine.

The total flour content in the composition is less than about 25% by weight, preferably from about 1% to about 25% by weight, more preferably from about 5% to about 20% by weight, and even more preferably from about 7% to about 15% by weight, based upon the total weight of all ingredients other than water taken as 100% by weight. Examples of suitable flours include those selected from the group consisting of soy flour, low fat soy flour, wheat flour, barley flour, oat flour, rice flour, corn flour, rye flour, buckwheat flour, and mixtures thereof.

It is preferred that the meat analogue composition is substantially free of leavening agents. Preferably, the meat analogue composition includes less than about 0.01% by weight leavening agents, more preferably less than about 0.001% by weight leavening agents, and even more preferably about 0% by weight leavening agents, based upon the total weight of all ingredients other than water taken as 100% by weight. As used herein, the term “leavening agent” means a substance that functions to cause a product to rise, such as by producing fermentation in the product. Examples of leavening agents include yeast and baking powder.

In one embodiment, it is preferred that the meat analogue composition is substantially free of potato starch. Preferably, the meat analogue composition includes less than about 0.01% by weight potato starch, more preferably less than about 0.001% by weight potato starch, and even more preferably about 0% by weight potato starch, based upon the total weight of all ingredients other than water taken as 100% by weight.

In a preferred embodiment, the inventive meat analogue composition further includes a component selected from the group consisting of oils and fats. In this embodiment, the total oil and/or fat content is less than about 25% by weight, preferably from about 0.1% to about 25% by weight, more preferably from about 0.1% to about 20% by weight, still more preferably from about 1% to about 15% by weight, and even more preferably from about 2% to about 10% by weight, based upon the total weight of all ingredients other than water taken as 100% by weight. Examples of suitable oils and fats include those selected from the group consisting of vegetable oil, canola oil, soybean oil, sunflower oil, cottonseed oil, safflower oil, olive oil, palm or tropical oils, nut oils, and mixtures thereof.

In another embodiment, the meat analogue composition further includes an antioxidant. In this embodiment, the total antioxidant content is preferably from about 0.001% to about 0.5% by weight, more preferably from about 0.01% to about 0.3% by weight, and even more preferably from about 0.04% to about 0.2% by weight, based upon the total weight of all ingredients other than water taken as 100% by weight. Examples of suitable antioxidants include lactic acid, ascorbic acid, tocopherols, rosemary extract, BHA, BHT, TBHQ, propyl gallate, and mixtures thereof.

As will be appreciated by those in the art, the amount of water added to the composition can be varied, depending upon the desired moisture content of the final meat analogue product and the type of meat being simulated. In a preferred embodiment, the total moisture content of the meat analogue product is from about 20% to about 70%, preferably from about 25% to about 55%, and more preferably from about 27% to about 45%, with the moisture content being based upon the total weight of the final meat analogue product.

Depending upon the final desired use and/or type of meat product being simulated, the inventive meat analogue compositions may also include a number of additional ingredients, including those selected from the group consisting of salt, acids, sugars, colors, spices, flavorings, seasonings, hydrolyzed vegetable proteins, smoke powder and/or liquid, preservatives and mixtures of the foregoing. In particular, the meat analogue composition preferably includes simulated meat flavorings such as pork flavor, pepperoni flavor, smoke powder, chicken flavor, beef flavor, seafood flavor, savory flavorings (e.g., onion, garlic), and mixtures thereof. In addition, thermally-preformed, texturized vegetable protein components are also preferably included in the composition when a sausage or pepperoni meat analogue is desired. Preferably, a pepperoni or sausage meat analogue composition comprises at least about 30% by weight of thermally-preformed, texturized vegetable protein, based upon the total weight of all ingredients in the composition other than water taken as 100% by weight. Suitable thermally-preformed, texturized vegetable protein components are widely available from a variety of sources and include meat analogue shreds, meat analogue extenders, and textured soy chunks.

The meat analogue composition preferably comprises a total protein content (from all protein sources in the composition) of at least about 30% by weight, more preferably from about 35% to about 85% by weight, still more preferably from about 40% to about 75% by weight, and even more preferably from about 40% to about 65% by weight, based upon the total weight of all ingredients in the composition other than water taken as 100% by weight. The total protein content is based upon the total contribution of protein from each of the protein sources in the meat analogue composition.

It is preferred that the inventive meat analogue compositions and products are substantially free of meat. As used herein, the term “meat” means animal tissue commonly used as food, such as skeletal tissue and associated fat, but also includes non-muscle organs. Preferably, the meat analogue composition and products include less than about 0.1% by weight meat, more preferably less than about 0.01% by weight meat, and even more preferably about 0% by weight meat, based upon the total weight of all ingredients in the composition other than water taken as 100% by weight.

It is also preferred that the meat analogue compositions, methods, and meat analogue products are free of any casing, resulting in casingless meat analogue products and methods of producing meat analogue products without the use of any casing to form the product.

The meat analogue products are formed by preparing a mixture of the meat analogue composition ingredients, including a vegetable protein, a dough conditioner, and water. The mixture is heated, and then passed through a heat exchanger to form the product. Preferably, the ingredients are mixed by introducing the ingredients into the inlet of an extruder. According to a particularly preferred method, the dry ingredients (all ingredients other than fats/oil, acids, and water) are blended and metered continuously into an extruder, while water is added to the dry blend after it enters the extruder. In this embodiment, water should be added to the extruder at a rate of from about 3 kg/hr to about 50 kg/hr, preferably from about 5 kg/hr to about 40 kg/hr, and even more preferably from about 8 kg/hr to about 35 kg/hr. Any other ingredients (fats, oils, acids, and/or others discussed above) are then preferably injected into the extruder barrel downstream, closer to the extruder outlet.

Preferably, the extruder comprises at least one flighted, axially rotatable screw, a barrel, an outlet, and a restriction plate positioned at the outlet. Even more preferably, the extruder is a twin-screw extruder. A description of a typical twin-screw extruder that could be used with the present invention can be found in U.S. Pat. No. 6,045,851 to Cross, incorporated by reference herein. The screw configuration(s) used in the extruder is preferably designed to present maximum mixing and kneading action. The screws are rotated at a speed of less than about 300 rpm, preferably less than about 250 rpm, more preferably less than about 200 rpm, and even more preferably from about 100 to about 200 rpm, in order to advance and mix the ingredients through the extruder barrel. More particularly, for a sausage-type analogue composition, such as a pepperoni analogue, the screws are preferably rotated of a speed of from about 180 to about 190 rpm.

The Specific Mechanical Energy (SME) provides a relational measurement of the shear experienced by the ingredients as they pass through the extruder barrel. That is, the SME is directly proportional to the shear experienced by the ingredients in the extruder barrel. SME is calculated according to the formula

$$\begin{matrix}Specific Mechanical Energy ( S M E ) \\ ( kW \text{/} kg \text{/} hr )\end{matrix} = \frac{[ \frac{r p m ( actual ) }{r p m ( maximum )} \times motor load \times kW of motor ]}{feed rate in kg \text{/} hr} .$$

In the inventive method, the SME experienced by the ingredients in the extruder barrel will vary depending upon the final desired meat analogue, and is preferably less than about 0.050 kW/kg/hr, more preferably from about 0.001 kW/kg/hr to about 0.050 kW/kg/hr, more preferably from about 0.003 kW/kg/hr to about 0.030 kW/kg/hr, and even more preferably from about 0.004 kW/kg/hr to about 0.020 kW/kg/hr. More specifically, in one embodiment, the preferred SME experienced by the ingredients in the extruder barrel is preferably from about 0.015 kW/kg/hr to about 0.020 kW/kg/hr. In another embodiment, the preferred SME experienced by the ingredients in the extruder barrel is preferably from about 0.004 kW/kg/hr to about 0.009 kW/kg/hr.

As the mixture advances along the length of the extruder barrel, the ingredients are mixed and heated (precooked) to a temperature preferably less than the gel point of the mixture. As used herein, the “gel point” is defined as the temperature at which irreversible gelation of the ingredient mixture occurs (i.e., when the ingredient mixture reaches an irreversible morphology) after which point, the product cannot be reformed and/or reshaped without breaking. The gel point of a mixture is based upon the ingredients in the composition, more specifically, the amount and type of vegetable protein, flour, oil, and/or fat in the mixture. The temperature of the ingredients in the extruder barrel will typically be from about 70° F. (21° C.) to about 200° F. (93.0° C.), more preferably from about 100° F. (37.8° C.) to about 175° F. (79.4° C.), and even more preferably from about 140° F. (60.0° C.) to 167° F. (75.0° C.). The retention time of the ingredients in the extruder barrel should be from about 5 seconds to about 120 seconds, and more preferably from about 15 seconds to about 40 seconds. The ingredients should be advanced through the barrel at a rate of from about 50 to about 160 lbs/hr, and more preferably from about 60 to about 140 lb s/hr.

Upon advancing through the extruder barrel, the precooked extrudate preferably exits through a restriction plate positioned at the extruder outlet. The restriction plate is preferably a pre-die consisting of a blocking plate, more preferably, the blocking plate comprises an opening of about 0.20 in². The restriction plate restricts the flow of the mixture through and out of the extruder barrel and creates a back pressure in the extruder barrel that develops immediately before the restriction plate. This pressure permits the mixture to be subjected to the mechanical energy input from the extruder screws. The pressure that develops immediately before the plate should be from about 10 psig to about 900 psig, preferably from about 50 psig to about 650 psig, and more preferably from about 100 psig to about 300 psig.

Upon passing through the restriction plate, the extrudate is passed through a forming heat exchanger to be heated or cooled, and shaped into the formed meat analogue product. It will be appreciated that a number of various dies may be used at the extruder outlet depending upon the desired final product. In preferred embodiments, the extrudate exiting the restriction plate and passed into the forming heat exchanger can be in the form of single or multiple ropes or strands of extrudate. In a further preferred embodiment, the heat exchanger is positioned adjacent to the extruder, and the extrudate is continuously fed directly from the extruder outlet into the heat exchanger inlet. The ability to form these products via a continuous process is particularly advantageous.

The heat exchanger forms the product by raising the temperature of the extrudate, preferably up to or above its gel point. For example, for sausage or pepperoni analogues, the internal temperature of the product upon exiting the forming heat-exchanger is preferably from about 120° F. (48.9° C.) to about 225° F. (107.2° C.), more preferably from about 150° F. (65.5° C.) to about 200° F. (93.3° C.), and even more preferably from about 160° F. (71.1° C.) to about 185° F. (85.0° C.). The retention time of the ingredients in the heat exchanger should be from about 30 seconds to about 200 seconds, and more preferably from about 60 to about 150 seconds. It is particularly preferred that the product travels through the heat exchanger in a laminar fashion with no mixing or agitation that would disrupt the formation of the gel structure within the extrudate to produce a self-sustaining body.

A preferred forming heat exchanger has a jacketed tube with an exterior diameter and a smaller interior diameter. The jacketed tube comprises a smaller pipe which the product flows through surrounded by an exterior pipe with sealed ends. The jacketed tube preferably has pressurized steam flowing through, which travels between the inner and outer pipes and conductively heats the meat analogue product up to and above its gelation temperature as it moves through the heat exchanger. The inner tube preferably has a diameter of from about 12.7 mm to about 50.8 mm, more preferably from about 25.4 mm to about 38.1 mm, and still more preferably about 33.05 mm. The exterior tube preferably has a diameter of from about 43.2 mm to about 81.3 mm, more preferably from about 55.9 mm to about 68.6 mm, and even more preferably about 63.5 mm. According to this embodiment, the product preferably exits the heat exchanger as a self-sustaining body in a cylindrical shape that can then be cut cross-sectionally into pepperoni-type slices.

In another preferred forming heat exchanger, the heating tube is formed from plate steel having electrical heating elements externally attached thereto. These heating elements heat the plate steel which conductively heats the meat analogue product up to and above its gelation temperature as it travels through the tube. Preferably, the heat exchanger has a cross section with a height of from about 3.175 mm to about 19.05 mm, more preferably from about 6.35 mm to about 12.7 mm, and even more preferably about 9.525 mm. The heat exchanger also preferably has a cross section with a width of from about 76.2 mm to about 228.6 mm, more preferably of from about 101.6 mm to about 203.2 mm, and still more preferably about 152.4 mm. According to this embodiment, the product preferably exits the heat exchanger as a self-sustaining body in a slab shape that can be cut cross-sectionally into cubes or dices.

The forming heat exchanger also preferably has a length of from about 1.52 m to about 3.35 m, more preferably from about 2.13 m to about 2.74 m, and even more preferably about 2.43 m. However, it will be appreciated by those skilled in the art that the dimensions of the forming heat exchanger can be varied from the preferred ranges and shapes above, without going outside of the scope of the present invention, depending upon the desired dimensions and shape of the final meat analogue product.

In a further embodiment of the present invention, more than one heat exchanger is used in the inventive process. Preferably, the inventive process involves anywhere from one to about four heat exchangers. More preferably, the heat exchangers are positioned in tandem, such that the inventive composition is fed directly from the outlet of one heat exchanger to the inlet of an adjacent heat exchanger, until the desired meat analogue product is achieved.

A significant advantage of the inventive methods is that upon exiting the forming heat exchanger, the meat analogue product is provided in a retained shape as a self-sustaining body without the use of any casing or skin. If necessary, the product may then be cooled to a temperature such that it is firm enough to be cut and still maintain the desired geometry.

The meat analogue product will be comprised of the ingredients used in the meat analogue composition, but in an amount that is about 60% of the ranges provided above, in relation to the composition. For example, the meat analogue product comprises at least about 9% of a vegetable protein, preferably from about 9% to about 54% by weight, more preferably from about 15% to about 39% by weight, and even more preferably from about 21% to about 30% by weight, based upon the total weight of the final product taken as 100% by weight. The total flour content will be less than about 15%, preferably from about 0.6% to about 15%, more preferably from about 3% to about 12%, and even more preferably from about 4.2% to about 9%, based upon the total weight of the final product taken as 100% by weight. The total dough conditioner content is at least about 0.0006% by weight, preferably from about 0.0006% to about 0.3% by weight, and more preferably from about 0.006% to about 0.18% by weight, and even more preferably from about 0.024% to about 0.12% by weight, based upon the total weight of the product taken as 100% by weight. The total oil and/or fat content of the meat analogue product is less than about 12% by weight, preferably from about 0.06% to about 12% by weight, more preferably from about 0.6% to about 9% by weight, and even more preferably from about 1.2% to about 6% by weight, based upon the total weight of the product taken as 100% by weight. Finally, the total protein content of the product (from all protein sources) will be at least about 18% by weight, preferably from about 21% to about 45% by weight, and more preferably from about 24% to about 42% by weight, based upon the total weight of the product taken as 100% by weight.

Texture profile analysis (as described in Examples 2 and 4) can be used to objectively measure the various sensory and textural characteristics of the final meat analogue product. Preferably, the meat analogue product has a texture profile determined by texture profile analysis that closely approximates the texture and taste of a full meat product. Two suitable measurements for characterizing the texture of a product are hardness and cohesiveness. Bourne, M. C., Food Texture and Viscosity: Concept and Measurement (2002), incorporated by reference herein. As used herein, “hardness” is defined as the height of the force peak of the first compression cycle, as measured on a TA-XT2 Texture Analyzer. The hardness need not occur at the point of deepest compression, although it typically does for most products. As used herein, “cohesiveness” is defined as the ability of the product to withstand a second deformation, relative to how it behaved under a first deformation, as measured on a TA-XT2 Texture Analyzer. The cohesiveness is calculated as the ratio of the amount of work of the second compression cycle over the amount of work of the first compression cycle.

As used herein, the “hardness” and “cohesiveness” values for the slices refer to measurements taken from the center of a stack of 10 slices of meat analogue product, where each slice has an average thickness of from about 0.8 mm to about 1.2 mm. Thus, when cut into slices, the meat analogue product should preferably have an average hardness of at least about 2,000 g, preferably from about 3,000 g to about 3,700 g, more preferably from about 3,200 g to about 3,500 g, and even more preferably from about 3,300 g to about 3,400 g. The meat analogue product slices should also have a cohesiveness of from about 0.40 to about 0.60, preferably from about 0.43 to about 0.57, more preferably from about 0.47 to about 0.55.

The “hardness” and “cohesiveness” values for the cubes, as used herein, refer to measurements taken on individual meat analogue cubes in random orientation, where the cubes have an average dimension of about 6 mm³ (±2). Thus, when cut into cubes, the meat analogue product should have an average hardness of at least about 245 g, preferably from about 400 g to about 1,200 g, more preferably from about 500 g to about 900 g, and even more preferably from about 600 g to about 800 g. The meat analogue cubes should also have a cohesiveness of from about 0.40 to about 1.0, preferably from about 0.60 to about 0.90, and more preferably from about to about 0.70 to about 0.80.

Finally, the meat analogue products will have an actual density of at least about 0.5 g/cm³, preferably from about 0.8 g/cm³ to about 2.0 g/cm³, and more preferably from about 1.0 g/cm³ to about 1.5 g/cm³.

It will be appreciated by those in the art that the meat analogue product may be cut into dices, slices, cubes, or any other desired geometry, and packaged and/or further processed as desired, depending upon the desired final use of the product. Advantageously, the meat analogue product of the present invention can be sliced or cut immediately after it exits the forming heat exchanger and does not need to be subjected to further processing steps or be (such as by smoking) to achieve a “sliceable” product. These methods are discussed in more detail below.

### EXAMPLES

The following examples set forth preferred methods in accordance with the invention. It is to be understood, however, that these examples are provided by way of illustration and nothing therein should be taken as a limitation upon the overall scope of the invention.

### Example 1

### Preparation of Pepperoni Analogue Logs

In this example, wheat-based, vegetable protein powder was used in a continuous extrusion process to create a meat analogue simulating the taste and texture of pepperoni. In a Hobart Blender, a 50 kg batch of dry ingredients (ingredients other than water, oil and acids) was blended for 10 minutes. The percentages by weight of the total ingredients (other than water) in the pepperoni analogue are set forth in Table 1, below. The total protein content of the composition from all protein sources was about 54% by weight, on a dry basis.

TABLE 1

| INGREDIENTS | % BY WEIGHT ^{a} |
|---|---|
| Vital Wheat Gluten | 40.332 |
| Chicken Analogue Shreds | 30.000 |
| Soy Flour | 7.300 |
| Soybean Oil | 6.800 |
| Pepperoni Pizza Flavor | 3.500 |
| Pork Flavor | 3.000 |
| Hydrolyzed Vegetable Protein | 1.750 |
| Sugar | 1.500 |
| Granulated Garlic | 1.500 |
| Black Pepper | 0.850 |
| Ground Fennel | 0.800 |
| Ground Anise | 0.800 |
| Salt | 0.500 |
| Citric Acid | 0.400 |
| Red #40 Lake | 0.200 |
| Ground Red Pepper | 0.200 |
| Lactic Acid | 0.200 |
| L-cysteine Hydrochloride | 0.101 |
| Ascorbic Acid | 0.101 |
| Oleoresin Paprika | 0.101 |
| Smoke Powder | 0.050 |
| Caramel Color | 0.015 |

^{a} Percentages are based upon the total weight of all ingredients other than water, taken as 100% by weight.

For the extrusion process, a Baker Perkins, Model MPF40, 25:1 L/D extruder was used with the screw configuration set forth in Table 2. The batch of dry ingredients was metered continuously into the extruder at a rate of 21.15 kg/hr. The extruder screws were rotated at 190 rpm. Immediately after the batch entered the extruder, water was added at a rate of 8.94 kg/hr. Vegetable oil and acids were added downstream, close to the outlet of the extruder, at a rate of 2.65 kg/hr. It was found that adding the acids downstream produced a more acceptable product, than adding the acids directly to the dry ingredients as they were metered into the extruder.

During the conveyance through the extruder, the meat analogue product reached a temperature of 166° F. (74.4° C.), and the pressure that developed before the restriction plate was 200 psi. The SME experienced by the ingredients in the extruder was about 0.017 kW/kg/hr. Upon advancing through the extruder barrel, the ingredients exited through a restriction plate positioned at the extruder outlet. A pre-die a consisting of a blocking plate with a 0.20 in² opening was used as the restriction plate. Upon passing through the restriction plate, the extrudate was then passed into a forming heat exchanger tube with the dimensions of 3.5 cm in diameter by 100 cm in length. The total time of the product in the exchanger was about 2.03 min. The internal temperature of the “cooked” meat analogue product upon exiting the forming heat exchanger was about 185° F. (85.0° C.).

After exiting the forming heat exchanger, the meat analogue product was cut by a knife to the desired length. The product was then individually quick frozen in a Victory, two-door, blast freezer.

TABLE 2

| | | | Cumu- | Paddle/ |
|---|---|---|---|---|
| | | Number | lative | Shearlock |
| Element | | of | Units | Orienta- |
| No. | Description | Elements | (L/D) | tion |
| 3001-108-1 | 1.5D Twin Lead Screw | 3 | 4.5 | |
| 3000-108-1 | 1.0D Twin Lead Screw | 2 | 6.5 | |
| 3004-108-1 | 0.25D Forward Paddle | 4 | 7.5 | 60° |
| 3001-108-1 | 1.5D Twin Lead Screw | 1 | 9 | |
| 3004-108-1 | 0.25 Forward Paddle | 1 | 9.25 | 0° |
| 3004-108-1 | 0.25 Forward Paddle | 1 | | 30° |
| 3004-108-1 | 0.25 Forward Paddle | 1 | | 30° |
| 3004-108-1 | 0.25 Forward Paddle | 1 | | 0° |
| 3004-108-1 | 0.25 Forward Paddle | 1 | | 30° |
| 3004-108-1 | 0.25 Forward Paddle | 1 | | 30° |
| 3004-108-1 | 0.25 Forward Paddle | 1 | | 0° |
| 3004-108-1 | 0.25 Forward Paddle | 1 | | 30° |
| 3004-108-1 | 0.25 Forward Paddle | 1 | | 30° |
| 3004-108-1 | 0.25 Forward Paddle | 1 | | 0° |
| 3004-108-1 | 0.25 Forward Paddle | 1 | | 30° |
| 3004-108-1 | 0.25 Forward Paddle | 1 | | 30° |
| 3004-108-1 | 0.25 Forward Paddle | 1 | | 0° |
| 3004-108-1 | 0.25 Forward Paddle | 1 | | 30° |
| 3004-108-1 | 0.25 Forward Paddle | 1 | | 30° |
| 3004-108-1 | 0.25 Forward Paddle | 1 | 13 | 0° |
| 3000-108-1 | 1.0D Twin Lead Screw | 2 | 15 | |
| 3004-108-1 | 0.25 Forward Paddle | 1 | | 0° |
| 3004-108-1 | 0.25 Forward Paddle | 1 | | 30° |
| 3004-108-1 | 0.25 Forward Paddle | 1 | | 0° |
| 3004-108-1 | 0.25 Forward Paddle | 1 | | 0° |
| 3004-108-1 | 0.25 Forward Paddle | 1 | | 30° |
| 3004-108-1 | 0.25 Forward Paddle | 1 | 16.5 | 0° |
| 3004-108-1 | 0.25 Forward Paddle | 1 | 16.75 | 30° |
| 3004-108-1 | 0.25 Forward Paddle | 1 | 17 | 0° |
| 3000-108-1 | 1.0D Twin Lead Screw | 1 | 18 | |
| 3004-108-1 | 0.25 Forward Paddle | 1 | 18.25 | 30° |
| 3004-108-1 | 0.25 Forward Paddle | 1 | 18.5 | 0° |
| 3004-108-1 | 0.25 Forward Paddle | 1 | | 0° |
| 3004-108-1 | 0.25 Forward Paddle | 1 | | 30° |
| 3004-108-1 | 0.25 Forward Paddle | 1 | | 0° |
| 3004-108-1 | 0.25 Forward Paddle | 1 | | 0° |
| 3004-108-1 | 0.25 Forward Paddle | 1 | | 30° |
| 3004-108-1 | 0.25 Forward Paddle | 1 | | 0° |
| 3004-108-1 | 0.25 Forward Paddle | 1 | | 0° |
| 3004-108-1 | 0.25 Forward Paddle | 1 | | 30° |
| 3004-108-1 | 0.25 Forward Paddle | 1 | | 0° |
| 3004-108-1 | 0.25 Forward Paddle | 1 | | 0° |
| 3004-108-1 | 0.25 Forward Paddle | 1 | | 30° |
| 3004-108-1 | 0.25 Forward Paddle | 1 | | 0° |
| 3004-108-1 | 0.25 Forward Paddle | 1 | | 0° |
| 3004-108-1 | 0.25 Forward Paddle | 1 | | 30° |
| 3004-108-1 | 0.25 Forward Paddle | 1 | 22.25 | 0° |
| 3004-108-1 | 0.25 Forward Paddle | 1 | 22.50 | 30° |
| 3004-108-1 | 0.25 Forward Paddle | 1 | 22.75 | 30° |
| 3000-108-1 | 1.0D Twin Lead Screw | 1 | 23.75 | |
| | 1.5D Discharge | | 25.25 | |
| | Camelback | | | |

### Example 2

### Texture Profile Analysis of Pepperoni Analogue Slices

In this example, the pepperoni analogue log prepared in Example 1 was cut into slices and subjected to texture analysis. Ten slices of pepperoni analogue were stacked and subjected to a puncture/fracture test. Each slice had a thickness of about 0.8-1.2 mm and a diameter of about 3.2-3.6 cm, with an average diameter of about 3.4 cm. The temperature of the pepperoni analogue was between 20-22° C., with a moisture content of 30.3%. The moisture content was determined using an oven-drying method (AOAC 950.46). Puncture/Fracture testing measurements were taken on a TA-XT2 Texture Analyzer, available from Texture Technologies Corporation. One measurement was taken from the center of the stacked slices. Four other measurements were taken from the sides of the slices (i.e., a location between the center and the perimeter of the stacked slices). The test was repeated four times on four stacks of pepperoni analogue slices. The program settings for the Texture Analyzer are set forth in Table 3 below.

TABLE 3

| SETTING | |
|---|---|
| Pre-Test Speed | 10 mm/second |
| Test Speed | 5 mm/second |
| Post-Test Speed | 5 mm/second |
| Rupture Test Distance | Not part of Fracture |
| | Texture Profile Analysis |
| Distance Probe Travels | 6 mm |
| (once tip makes contact with test product) | |
| Time | 5 seconds |
| (lag between 1st and 2nd compression) | |
| Trigger Type | Auto |
| Force | 20 grams |
| Stop Plot At | Trigger Return |

The results of the Texture Profile Analysis are provided in Table 4 below. Hardness is defined as the height of the force peak on the first compression cycle (force 1st peak). The cohesiveness is calculated as the ratio of the amount of work of the 2nd peak area over the amount of work of the first peak area (Work 1st Peak Area/Work 2nd Peak Area). Bourne, M. C., Food Texture and Viscosity: Concept and Measurement 184 (2002). The average hardness value as measured from the center of the slices was about 3325 g, and as measured from the center and sides of the slices was about 3,541.8 g. The average cohesiveness value as measured from the center of the slices was about 0.5075, and as measured from the center and sides of the slices was about 0.5305.

TABLE 4

| | | Force | Force | Work | | |
|---|---|---|---|---|---|---|
| | | 1st | 2nd | 1st Peak | Work | |
| | Puncture | Peak | Peak | Area | 2nd Peak | Cohesive- |
| STACK | Location | (g) | (g) | (g/s) | Area (g/s) | ness |
| 1 | Center | 3314.9 | 2619.2 | 2518 | 1392 | 0.55 |
| | Side | 3642.0 | 2851.4 | 2742 | 1432 | 0.52 |
| | Side | 3281.4 | 2571.5 | 2604 | 1363 | 0.52 |
| | Side | 3325.7 | 2656.6 | 2497 | 1433 | 0.57 |
| | Side | 3148.9 | 2326.3 | 2428 | 1238 | 0.51 |
| 2 | Center | 3637.1 | 2801.0 | 2856 | 1391 | 0.49 |
| | Side | 3973.2 | 3153.0 | 2894 | 1667 | 0.57 |
| | Side | 3797.1 | 2884.7 | 2838 | 1387 | 0.49 |
| | Side | 3694.4 | 2823.1 | 2688 | 1439 | 0.53 |
| | Side | 3866.7 | 3021.5 | 2726 | 1555 | 0.57 |
| 3 | Center | 3222.8 | 2445.5 | 2405 | 1136 | 0.47 |
| | Side | 3524.5 | 2661.8 | 2436 | 1263 | 0.52 |
| | Side | 3818.6 | 2959.7 | 2684 | 1433 | 0.53 |
| | Side | 3809.2 | 3038.3 | 2959 | 1550 | 0.52 |
| | Side | 4140.3 | 3217.6 | 3094 | 1590 | 0.51 |
| 4 | Center | 3125.2 | 2148.0 | 2318 | 1210 | 0.52 |
| | Side | 3352.4 | 2566.6 | 2395 | 1352 | 0.56 |
| | Side | 3228.9 | 2489.3 | 2613 | 1349 | 0.52 |
| | Side | 3228.2 | 2590.0 | 2212 | 1314 | 0.59 |
| | Side | 3704.7 | 2852.1 | 2768 | 1530 | 0.55 |

| | | | | | |
|---|---|---|---|---|---|
| MEAN | 3541.8 | 2733.9 | 2633.8 | 1401.2 | 0.5305 |

### Example 3

### Preparation of Pepperoni Analogue Slabs

In this example, wheat-based vegetable protein powder was used in a continuous extrusion process to create a meat analogue simulating the taste and texture of pepperoni. In a Hobart Blender, a 50 kg batch of dry ingredients (ingredients other than water, oil and acids) was blended for 10 minutes. The percentages by weight of the total ingredients other than water in the pepperoni analogue were the same as those set forth in Table 1, above.

For the extrusion process, the same screw configuration was used as in Table 2, above. The batch of dry ingredients was metered continuously into the extruder at a rate of 56.75 kg/hr. The screws were rotated at 190 rpm. Immediately after the batch entered the extruder, water was added at a rate of 32.28 kg/hr. Vegetable oil and acids were added downstream, close to the outlet of the extruder at a rate of 2.88 kg/hr.

During the conveyance through the extruder, the meat analogue product reached a temperature of 166° F. (74.4° C.), and the pressure that developed before the restriction plate was 200 psi. The SME experienced by the ingredients in the extruder was about 0.017 kW/kg/hr. Upon advancing through the extruder barrel, the ingredients exited through a restriction plate positioned at the extruder outlet. Upon passing through the restriction plate, the extrudate was then passed into a forming heat exchanger tube having the dimension of 15.24 cm in width by 177.80 cm in length. The total time of the meat analogue product in the heat exchanger tube was about 2.09 min. The internal temperature of the “cooked” meat analogue product upon exiting the forming heat exchanger was about 185° F. (85.0° C.).

After exiting the forming heat exchanger, the meat analogue product was cut by a Model M Urschel Dicer into cubes. The meat analogue product was then individually quick frozen in a Victory, two-door, blast freezer.

### Example 4

### Texture Profile Analysis of Pepperoni Analogue Slab Cubes

In this example, the pepperoni analogue cubes prepared in Example 3 were subjected to texture analysis. Sixteen cubes of the diced pepperoni analogue slab were individually subjected to a compression/puncture test. Each cube had the dimensions of 6 mm³ (±2 mm). The temperature of the pepperoni analogue was between 20-22° C., with a moisture content of 42.6%. The moisture content was determined using an oven-drying method (AOAC 950.46). Compression/Puncture testing measurements were taken on a TA-XT2 Texture Analyzer, available from Texture Technologies Corporation. One measurement was taken from each cube and the orientation of the cubes were randomly chosen. The program settings for the Texture Analyzer are set forth in Table 5 below.

TABLE 5

| SETTING | |
|---|---|
| Pre-Test Speed | 10 mm/second |
| Test Speed | 5 mm/second |
| Post-Test Speed | 5 mm/second |
| Rupture Test Distance | Not part of Fracture |
| | Texture Profile Analysis |
| Distance Probe Travels | 3 mm |
| (once tip makes contact with test product) | |
| Time | 5 seconds |
| (lag between 1st and 2nd compression) | |
| Trigger Type | Auto |
| Force | 20 grams |
| Stop Plot At | Trigger Return |

The results of the Texture Profile Analysis are provided in Table 6 below. The average hardness value of the cubes was about 702.3 g. The average cohesiveness of the cubes was about 0.7406.

TABLE 6

| | | | | Work | | |
|---|---|---|---|---|---|---|
| | | Force | Force | 1st Peak | Work | |
| | Puncture | 1st | 2nd | Area | 2nd Peak | Cohesive- |
| CUBE | Location | Peak (g) | Peak (g) | (g/s) | Area (g/s) | ness |
| 1 | Random | 606.2 | 584.5 | 284.2 | 228.2 | 0.80 |
| 2 | Location | 784.1 | 728.1 | 357.1 | 273.8 | 0.77 |
| 3 | | 699.6 | 638.5 | 326.0 | 238.2 | 0.73 |
| 4 | | 619.0 | 561.4 | 266.8 | 198.7 | 0.74 |
| 5 | | 613.2 | 588.3 | 279.9 | 214.2 | 0.77 |
| 6 | | 544.8 | 467.5 | 225.4 | 161.3 | 0.72 |
| 7 | | 1002.9 | 912.7 | 463.5 | 352.0 | 0.76 |
| 8 | | 917.7 | 864.5 | 415.3 | 327.7 | 0.79 |
| 9 | | 1110.9 | 981.4 | 492.9 | 397.3 | 0.81 |
| 10 | | 680.0 | 608.2 | 304.7 | 255.1 | 0.84 |
| 11 | | 745.6 | 689.9 | 332.1 | 259.1 | 0.78 |
| 12 | | 955.1 | 851.9 | 419.2 | 327.4 | 0.78 |
| 13 | | 542.0 | 457.6 | 226.4 | 148.5 | 0.66 |
| 14 | | 245.3 | 173.3 | 117.4 | 53.9 | 0.46 |
| 15 | | 746.6 | 661.8 | 351.3 | 264.2 | 0.75 |
| 16 | | 423.1 | 377.2 | 179.7 | 124.7 | 0.69 |
| MEAN | | 702.3 | 634.2 | 315.1 | 239.0 | 0.7406 |

### Example 5

### Comparative Texture Profile Analysis of Prior Art Meat Analogue

In this example, a pepperoni analogue commercialized under the name Smart Deli® Pepperoni Slices (Lightlife Foods, Massachusetts) was subjected to texture analysis for comparison to the inventive meat analogues. Eight slices of Smart Deli® Pepperoni were stacked and subjected to a puncture/fracture test. Each slice had a thickness of about 1.8-2.2 mm and a diameter of about 3.8-4.2 cm, with an average diameter of about 4.0 cm. The temperature of the Smart Deli® Pepperoni was between 20-22° C., with a moisture content of 50%. The moisture content was determined using an oven-drying method (AOAC 950.46). Puncture/Fracture testing measurements were taken on a TA-XT2 Texture Analyzer, available from Texture Technologies Corporation. One measurement was taken from the center of the stacked slices. Four other measurements were taken from a location between the center and the perimeter of the stacked slices. The test was repeated four times on four stacks of Smart Deli® Pepperoni slices. The program settings for the Texture Analyzer are set forth in Table 3 above. The results of the Texture Profile Analysis are provided in Table 7 below. The average hardness value as measured from the center of the slices was about 765.825 g. The average cohesiveness of the slices, as measured from the center, was about 0.6575.

TABLE 7

| | | Force | Force | Work | | |
|---|---|---|---|---|---|---|
| | | 1st | 2nd | 1st Peak | Work | |
| | Puncture | Peak | Peak | Area | 2nd Peak | |
| STACK | Location | (g) | (g) | (g/s) | Area (g/s) | Cohesiveness |
| 1 | Center | 815.7 | 722.9 | 724.8 | 467.6 | 0.64 |
| | Side | 914.2 | 686.9 | 794.3 | 432.4 | 0.54 |
| | Side | 888.2 | 727.6 | 797.6 | 442.3 | 0.56 |
| | Side | 775.2 | 642.0 | 673.8 | 390.0 | 0.58 |
| | Side | 882.4 | 668.4 | 780.5 | 422.5 | 0.54 |
| 2 | Center | 704.7 | 619.6 | 530.2 | 381.5 | 0.72 |
| | Side | 862.4 | 718.1 | 681.8 | 458.0 | 0.67 |
| | Side | 903.7 | 735.9 | 748.4 | 479.0 | 0.64 |
| | Side | 777.8 | 690.6 | 590.6 | 453.6 | 0.77 |
| | Side | 847.0 | 678.3 | 690.2 | 450.2 | 0.65 |
| 3 | Center | 822.6 | 669.7 | 665.2 | 437.6 | 0.66 |
| | Side | 762.8 | 634.9 | 632.9 | 398.0 | 0.63 |
| | Side | 746.2 | 614.2 | 614.3 | 365.0 | 0.64 |
| | Side | 691.0 | 590.4 | 620.0 | 380.2 | 0.61 |
| | Side | 750.2 | 617.3 | 617.1 | 397.0 | 0.64 |
| 4 | Center | 720.3 | 572.5 | 614.5 | 372.1 | 0.61 |
| | Side | 867.8 | 725.1 | 721.5 | 479.6 | 0.67 |
| | Side | 820.7 | 688.2 | 673.5 | 430.2 | 0.64 |
| | Side | 720.8 | 639.0 | 597.4 | 411.0 | 0.69 |
| | Side | 701.4 | 575.1 | 606.4 | 341.0 | 0.56 |

| | | | | | |
|---|---|---|---|---|---|
| MEAN | 798.8 | 660.8 | 668.7 | 420.9 | 0.63 |

1. A method of forming a meat analogue product, said method comprising:
(a) preparing a mixture of ingredients including at least one vegetable protein, a dough conditioner, and water;
(b) heating said mixture to a temperature not exceeding the gel point of said mixture; and
(c) passing said mixture resulting from (b) through a heat exchanger to form said meat analogue product.

2. The method of claim 1, wherein:
said preparing comprises:
introducing said ingredients into an extruder, said extruder comprising a barrel, at least one flighted, axially rotatable screw, and an outlet; and
rotating said screw to mix and advance said ingredients along the length of said extruder barrel; and
said heating comprises heating said mixture inside said barrel.

3. The method of claim 2, said ingredients being continuously introduced into said extruder.

4. The method of claim 2, said method further comprising:
passing said mixture through said outlet to yield an extrudate; and
passing said extrudate directly to said heat exchanger to form said meat analogue product.

5. The method of claim 4, said heat exchanger comprising an inlet and being positioned adjacent to said extruder, wherein said extruder outlet continuously feeds said extrudate into said heat exchanger inlet.

6. The method of claim 2, wherein said ingredients achieve a temperature inside said extruder of from about 70° F. to about 200° F.

7. The method of claim 2, wherein said ingredients are retained in said extruder barrel for a time period of from about 5 seconds to about 120 seconds.

8. The method of claim 1, wherein said mixture includes a component selected from the group consisting of oils, fats, acids, and mixtures thereof.

9. The method of claim 1, wherein the temperature of said mixture in said heat exchanger increases above said gel point.

10. The method of claim 1, said vegetable protein being selected from the group consisting of vital wheat gluten, soy protein isolate, soy protein concentrate, pea protein, pea protein concentrate, and mixtures thereof.

11. The method of claim 1, said dough conditioner being selected from the group consisting of L-cysteine, sulfites, dextrin, reduced glutathione, transglutamase, derivatives or sources of the foregoing, and combinations of the foregoing.

12. The method of claim 2, wherein said screw rotates at a speed of less than about 300 rpm.

13. The method of claim 2, wherein said ingredients are advanced through said extruder barrel at a rate of from about 50 lbs/hr to about 160 lbs/hr.

14. The method of claim 1, wherein said ingredients are retained in the heat exchanger for a time period of from about 30 to about 300 seconds.

15. A meat analogue composition comprising a mixture of ingredients, including a vegetable protein, a dough conditioner that disrupts disulfide bonds between and within protein molecules, and less than about 25% by weight flour, said percentages by weight being based upon the total weight of all ingredients other than water, taken as 100% by weight.

16. The composition of claim 15, said composition further comprising less than about 20% by weight of an ingredient selected from the group consisting of oils and fats.

17. The composition of claim 15, said vegetable protein being selected from the group consisting of vital wheat gluten, soy protein isolate, soy protein concentrate, pea protein, pea protein concentrate, and mixtures thereof.

18. The composition of claim 15, said dough conditioner being selected from the group consisting of L-cysteine, sulfites, reduced glutathione, transglutamase, derivatives or sources of the foregoing, and combinations of the foregoing.

19. The composition of claim 15, said ingredients comprising:
from about 15% to about 90% by weight of said vegetable protein; and
from about 0.001% to about 0.5% by weight of said dough conditioner, said percentages by weight being based upon the total weight of all ingredients other than water, taken as 100% by weight.

20. The composition of claim 15, said dough conditioner comprising L-cysteine hydrochloride.

21. The composition of claim 15, said composition further comprising an additive selected from the group consisting of salt, acids, sugar, colors, spices, flavorings, seasonings, hydrolyzed vegetable proteins, smoke powder and/or liquid, liquid preservatives, thermally preformed texturized protein components, and mixtures of the foregoing.

22. The composition of claim 15, said composition being substantially free of meat.

23. The composition of claim 15, said composition being substantially free of leavening agents.

24. A meat analogue product comprising a self-sustaining body, said body comprising a vegetable protein, a dough conditioner that disrupts disulfide bonds between and within protein molecules, and less than about 15% by weight flour, based upon the total weight of the body taken as 100% by weight, said body having a hardness of at least about 2,000 g.

25. The product of claim 24, said body having a moisture content of from about 20% to about 70% by weight, based upon the total weight of the body taken as 100% by weight.

26. The product of claim 24, said body having an actual density of at least about 0.8 g/cm³.

27. The product of claim 24, said body further comprising less than about 12% by weight of an ingredients selected from the group consisting of fats and oils, based upon the total weight of the body taken as 100% by weight.

28. The product of claim 24, said body being free of any casing.

29. The product of claim 24, said body being substantially free of meat.
